(19) United States
(12) Patent Application Publication
(10) Pub. No.: US 2026/0195451 A1
(43) Pub. Date: Jul. 9, 2026

(54) A Method to Prevent Exploitation of an AI Module in an AI System

(71) Applicants: Robert Bosch GmbH, Stuttgart (DE); Bosch Global Software Technologies Private Limited, Bangalore (IN)

(72) Inventors: Adit Jignesh Shah, Ahmedabad (IN); Manojkumar Somabhai Parmar, Ahmedabad, Gujarat (IN); Pankaj Kanta Maurya, Umbergaon, Gujarat (IN); Mayurbhai Thesia Yash, Ahmedabad, Gujarat (IN)

(21) Appl. No.: 19/132,803

(22) PCT Filed: Nov. 29, 2023
(86) PCT No.: PCT/EP2023/083570

§ 371 Date: May 24, 2025

(30) Foreign Application Priority Data
Nov. 29, 2022 (IN) 2022 4106 8483

(51) Int. Cl. G06F 21/55

(52) U.S. Cl. CPC G06F 21/554; G06F 2221/033

(57) ABSTRACT

A method to prevent exploitation of an AI module in an AI system is disclosed. The AI system includes an input interface, an output interface, an AI module, a submodule an information gain module and at least a blocker module. The submodule is configured to add a pre-defined noise to the received input to generate a noisy input and feed the noisy input to the AI module to generate a second output. The submodule compares a first output generated by the AI module based on processing of input and the second output to identify an attack vector in the input. A difference in class of the first output and the second output identifies an input as attack vector.

The following specification describes and ascertains the nature of this invention and the manner in which it is to be performed.

### FIELD OF THE INVENTION

The present disclosure relates to the field of artificial intelligence (AI) security. In particular, the present disclosure proposes a method to prevent exploitation of an AI module in an AI system and the system thereof.

### BACKGROUND OF THE INVENTION

With the advent of data science, data processing and decision-making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically, the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to exploitation/copy/extract the model from AI systems. The adversary may use different techniques to exploit the model from the AI systems. One of the simple techniques used by the adversaries is where the adversary sends different queries to the AI system iteratively, using its own test data. The test data may be designed in a way to extract internal information about the working of the models in the AI system. The adversary uses the generated results to train its own models. By doing these steps iteratively, it is possible to exploitation the internals of the model and a parallel model can be built using similar logic. This will cause hardships to the original developer of the AI systems. The hardships may be in the form of business disadvantages, loss of confidential information, loss of lead time spent in development, loss of intellectual properties, loss of future revenues etc. Hence there is a need for an AI system that is self-sufficient in averting adversarial attacks and identifying and attack vector.

There are methods known in the prior arts to identify such attacks by the adversaries and to protect the models used in the AI system. The prior art US 20190095629A1—Protecting Cognitive Systems from Model Stealing Attacks discloses one such method. It discloses a method wherein the input data is processed by applying a trained model to the input data to generate an output vector having values for each of the plurality of pre-defined classes. A query engine modifies the output vector by inserting a query in a function associated with generating the output vector, to thereby generate a modified output vector. The modified output vector is then output. The query engine modifies one or more values to disguise the trained configuration of the trained model logic while maintaining accuracy of classification of the input data.

### BRIEF DESCRIPTION OF THE ACCOMPANYING DRAWINGS

An embodiment of the invention is described with reference to the following accompanying drawings:

FIG. 1 depicts an AI system (100) for processing of an input;

FIG. 2 illustrates method steps (200) to prevent exploitation of an AI module (12) in an AI system (100).

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI module. An AI module with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. Clustering or grouping is the detection of similarities in the inputs. The cluster learning techniques do not require labels to detect similarities. Learning without labels is called unsupervised learning.

Unlabeled data is the majority of data in the world. One law of machine learning is: the more data an algorithm can train on, the more accurate it will be. Therefore, unsupervised learning models/algorithms has the potential to produce accurate models as training dataset size grows.

As the AI module forms the core of the AI system, the module needs to be protected against attacks. AI adversarial threats can be largely categorized into model extraction attacks, inference attacks, evasion attacks, and data poisoning attacks. In poisoning attacks, the adversarial carefully inject crafted data to contaminate the training data which eventually affects the functionality of the AI system. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model.

In Model Extraction Attacks (MEA), the attacker gains information about the model internals through analysis of input, output, and other external information.

Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is black box model attack vector where no prior knowledge of original model is required. As the prior information regarding model is available and increasing, attacker moves towards more intelligent attacks. The attacker chooses relevant dataset at his disposal to extract model more efficiently. This is domain intelligence model-based attack vector. With these approaches, it is possible to demonstrate model stealing attack across different models and datasets.

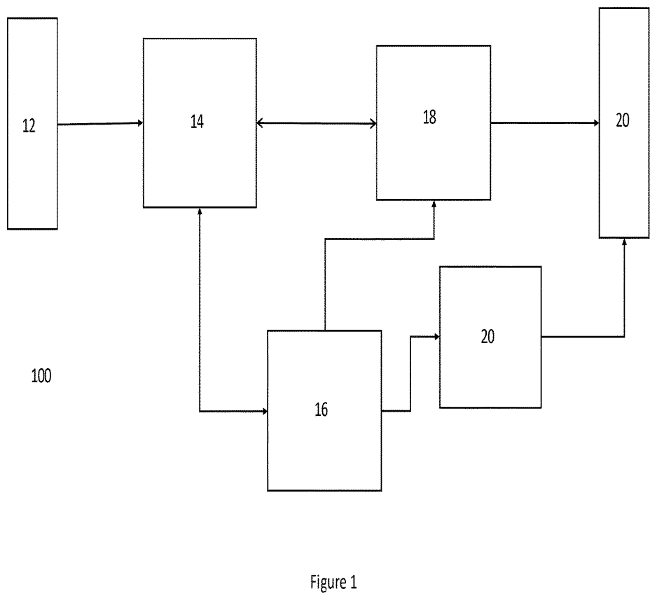

FIG. 1 depicts an AI system (100) for processing of an input. The AI system (100) comprises an input interface (10), an output interface (18), an AI module (12), a submodule (16) an information gain module (20) and at least a blocker module (14).

A module with respect to this disclosure can either be a logic circuitry or a software programs that respond to and processes logical instructions to get a meaningful result. A module is implemented as any or a combination of: one or more microchips or integrated circuits interconnected using a parent board, hardwired logic, software stored by a memory device and executed by a microprocessor, microcontrollers, firmware, an application specific integrated circuit (ASIC), and/or a field programmable gate array (FPGA). As explained above, these various modules can either be a software embedded in a single chip or a combination of software and hardware where each module and its functionality is executed by separate independent chips connected to each other to function as the system. For example, an AI module (12)) mentioned herein after can be a software residing in the system or the cloud or embodied within an electronic chip. Alternatively, we can have neural network chips that are specialized silicon chips, which incorporate AI technology and are used for machine learning.

The input interface (10) is an hardware interface wherein a user can enter his query for the AI module (12) to process and generate an output. The input interface (10) receives input from at least one user through an audio or visual means. Similarly, the output interface (18) sends an output to said at least one user via an audio or visual means.

The AI module (12) is configured to process said input data. An AI module (12) with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module (12) and can be applied to any AI module (12) irrespective of the AI model being executed. A person skilled in the art will also appreciate that the AI module (12) may be implemented as a set of software instructions, combination of software and hardware or any combination of the same.

The AI system (100) is characterized by the functionality of the submodule (16). The submodule (16) is configured to add a pre-defined noise to the received input to generate a noisy input. Next the submodule (16) feeds the noisy input to the AI module (12) to generate a second output. The submodule (16) compares the first output and second output of the AI module (12) to identify an attack vector in the input. A difference in class of the first output and the second output identifies an input as attack vector. Further, the submodule (16) communicates the identification information with the information gain module (20).

The information gain module (20) is configured to calculate an information gain and send the information gain value to a blocker module (14). Information gain is a quantitative analysis of the portion of AI model stolen or compromised due to the impact of an attack vector.

The blocker module (14) is configured to block a user based on the information gain. Information gain is calculated when input attack queries exceeds a predefined threshold value. The blocker module (14) is further configured to modify a first output generated by an AI module (12). The output sent by the output interface is a modification of the first output when the submodule (16) identifies an attack vector in the input. Further, the blocker module (14) transmits a notification to the owner of said AI system (100). The notification is an audio or visual notification sent to the owner of the AI system (100) as to the AI module (12) being attacked by an adversary or being compromised.

It should be understood at the outset that, although exemplary embodiments are illustrated in the figures and described below, the present disclosure should in no way be limited to the exemplary implementations and techniques illustrated in the drawings and described below. In one embodiment of the architectural framework all the building block of the AI system (100) are implemented in hardware i.e. each building block may be hardcoded onto a microprocessor chip. This is particularly possible when the building blocks are physically distributed over a network, where each building block is on individual computer system across the network. In another embodiment of the architectural framework of the AI system (100) are implemented as a combination of hardware and software i.e. some building blocks are hardcoded onto a microprocessor chip while other building block are implemented in a software which may either reside in a microprocessor chip or on the cloud. Each building block of the AI system (100) in one embodiment would have an individual processor and a memory.

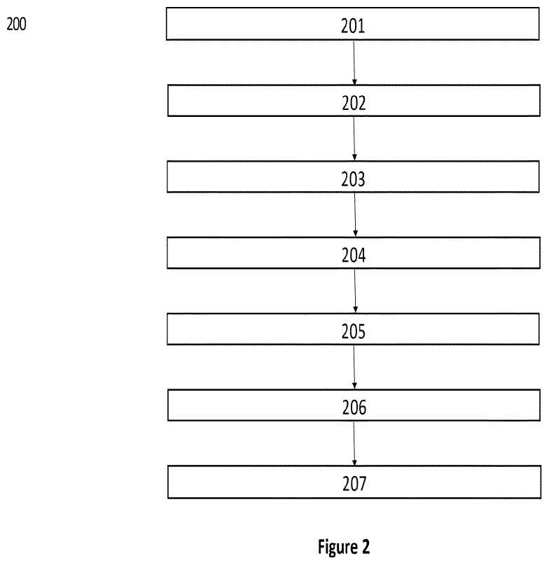

FIG. 2 illustrates method steps to prevent exploitation of an AI module (12) in an AI system (100). The AI system (100) and its components have been described in accordance with FIG. 1. A person skilled in the art will appreciate that while these method steps describe only a series of steps to accomplish the objectives, these methodologies may be implemented with variation and adaptation to the AI system (100) described herein.

Method step 201 comprises receiving input from at least one user through an input interface in the AI system. Method step 202 comprises transmitting the input through the submodule (16) to the AI module (12) to generate a first output.

Method step 203 comprises adding a pre-defined noise to the received input by means of the submodule (16) to generate a noisy input. As an example, predefined noise is generated using white noise generation method based on data distribution and sensitivity of model towards a noise. We take a single data point and add a white noise with varies strengths till the model mis classifies the input. Upon mis classification, the strength of white noise is recorded. We do the same for all input in training sample and get the distribution of strength of noise level. We take 10^{th} percentile strength of noise value to be deployed in system to add the predefined noise. The 10^{th} percentile value means that probability of original input detected as attacks are only 10% and conversely the confidence that identified attack vector is attack at 90%. The threshold of 10^{th} percentile is for the reference, and it can be changed depending on need of system performance.

Method step 204 comprises feeding the noisy input to the AI module (12) to generate a second output. Method step 205 comprises comparing the first output and the second output by means of the submodule (16) to identify an attack vector input. The underlying concept here is that the AI module (12) is originally trained to classify input into n classes. All these n classes have definite classification boundary. Generally genuine data (non-attack vector) lies will within the classification boundary and attack vector lies very close to classification boundary. Addition of pre-defined noise in attack vector will make it jump to different class. However, adding noise to genuine image will still give the same class with less accuracy. For example, let's take an AI module trained to classify images into “n” classes animal (say cats and dogs). Now we take the original input and the predefined noise to it. The noisy input and the original input are fed to the AI module (12). If the second output and first output class are different (example the first output says cat and the second output says a dog), it indicates the input is an attack vector.

Method step 206 comprises communicating the identification information to an information gain module (20). Method step 207 comprises sending an output by means of the output interface to prevent exploitation of the AI module (12). The first output is modified and sent as the output on identification of an attack vector in the input. Every time an input is recognized as an attack vector the input and the user are flagged by the blocker module (14). During computation of the information gain if the information gain exceeds a certain pre-defined threshold then the user is blocked from using and accessing the AI module (12). A user is blocked by a blocker module (14) in dependence of information received from the information gain module (20).

In certain cases it is also possible, that there may be plurality of user sending attack vectors. In this case, the information gain extracted by one single user would not be alarming to block the user. In this case, the cumulative information gain is computed by the Information gain module (20) and the blocker module (14) blocks out the entire AI system. If the information gain extracted during a single instance of inputting bad data or attack vector is less than pre-defined threshold then the AI module (12) will provide some output i.e. a modified output through the output interface (18).

Flagging of the user would be based on the user profile. The following information may be used to store information regarding the user: types of the bad data/attack vectors provided by the user, number of times the user input bad data/attack vector, the time of the day when bad data/attack vector was inputted to the AI system, the physical location of the user, the digital location of user, the demographic information of the user and the like. In addition, the user profile may be used to determine whether the user is habitual attacker or was it one time attack or was it only incidental attack etc. Depending upon the user profile, the steps for unlocking of the system may be determined. If it was first time attacker, the user may be locked out temporarily. If the attacker is habitual attacker then a stricter locking steps may be suggested. Once the system is locked, there is also a mechanism and criteria to unlock the AI system (100). The AI system 10 may be unlocked only after an unlocking criteria is met. The unlocking criteria may be a certain event, for example, a fixed duration of time, a fixed number of right inputs, a manual override etc.

This idea to develop a method to prevent exploitation of an AI module (12) in an AI system (100) helps detect many unknown attack vectors, since its detection mechanism is semi-supervised. It must be understood that the embodiments explained in the above detailed description are only illustrative and do not limit the scope of this invention. Any variations and adaptions to the method to prevent exploitation of an AI module (12) in an AI system (100) are envisaged and form a part of this invention. The scope of this invention is limited only by the claims.

1. An artificial intelligence system for processing of an input, comprising:
an input interface configured to receive input from at least one user;
an AI module configured to process the input and generate a first output;
an output interface configured to the send an output to the at least one user;
a blocker module configured to block the at least one user;
an information gain module configured to calculate an information gain and send the information gain value to the blocker module; and
a submodule configured to:
add a pre-defined noise to the received input to generate a noisy input;
feed the noisy input to the AI module to generate a second output;
compare the first output and second output of the AI module to identify an attack vector in the input; and
communicate the identification information with the information gain module.

2. The artificial intelligence system as claimed in claim 1, wherein a difference in class of the first output and the second output identifies an input as attack vector.

3. The artificial intelligence system as claimed in claim 1, wherein the pre-defined noise is generated using white noise generation method based on data distribution and sensitivity of model towards a noise.

4. The artificial intelligence system as claimed in claim 1, wherein the output sent by the output interface is a modification of the first output when the submodule identifies an attack vector in the input.

5. A method to prevent exploitation of an AI module in an AI system said AI system further comprising at least a submodule the method comprising:
receiving input from at least one user through an input interface in the AI system transmitting the input through the submodule to the AI module to generate a first output;
adding a pre-defined noise to the received input by way of the submodule to generate a noisy input;
feeding the noisy input to the AI module to generate a second output;
comparing the first output and the second output by way of the submodule to identify an attack vector input;
communicating the identification information to an information gain module and
sending an output by way of the output interface to prevent exploitation of the AI module

6. The method as claimed in claim 5, wherein the pre-defined noise is generated using white noise generation method based on data distribution and sensitivity of model towards a noise.

7. The method as claimed in claim 5, wherein a difference in class of the first output and the second output identifies an input as attack vector.

8. The method to as claimed in claim 5, wherein the first output is modified and sent as the output on identification of an attack vector in the input.

9. The method AI as claimed in claim 5, wherein the at least one user is blocked by a blocker module in dependence of on information received from the information gain module.
